(19) United States
(12) Patent Application Publication
(10) Pub. No.: US 2005/0125249 A1
(43) Pub. Date: Jun. 9, 2005

(54) Method, program, and system of measuring the effect of investment in an IT system

(76) Inventors: Shunji Takubo, Kodaira (JP); Ken Naono, Tachikawa (JP); Masashi Egi, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/985,046

(22) Filed: Nov. 10, 2004

(30) Foreign Application Priority Data
Nov. 11, 2003 (JP) 2003-381622

(51) Int. Cl. G06F 17/60

(52) U.S. Cl. 705/1

(57) ABSTRACT

Provided is a method of measuring the effect of investment in an IT system by calculating the correlation between data on profit derived from an IT system. Various time-series data collected from a business system are classified into a profit indicator (104), a business process progress status indicator (105), and a system operation status indicator (106), and the correlation between those data is found. From the correlation, a contribution ratio indicative of the influence of the IT system operation status on the profit is calculated, and the effect of investment in the IT system is measured based on this contribution ratio.

### CLAIM OF PRIORITY

The present application claims priority from Japanese application P2003-381622 filed on Nov. 11, 2003, the content of which is hereby incorporated by reference into this application.

### BACKGROUND

This invention relates to a technique of measuring the effect of investment in an IT system built by a business organization or the like.

Lately, efficiency is pursued in investing in IT (information communication technology) systems as is elsewhere and people have come to pay closer attention than ever to ROI (Return On Investment) in IT systems. Now there is a need to estimate, before an IT system is introduced, how much benefit the system will bring and, after the system is installed, to monitor the operation status of the system constantly for evaluation of the system's contribution to increase in profit which is to be reflected in future IT investment strategies.

Against this background, methods and tools of evaluating the effect of investment in an IT system are being explored. An example of such tools is a system with which indicators such as receipts and payments for equipment, business cash flow, securities income and expense, and loan payable are calculated from financial statements inputted as data and, of the calculation results, ones that meet the purpose of analysis are displayed in the form of graph (JP 2001-188827 A).

The cited invention enables a user to visually grasp changes with time in amount of equipment investment such as IT investment and business cash flow and to judge the influence of the equipment investment over business cash flow, thus providing the user with decision-making materials to decide whether the equipment investment has been a success or not.

Another example is simple diagnosis software about computerization (JP 2002-352060 A). A company considering, or having troubles with, computerization consults a diagnostician (consultant) who conducts a preliminary survey and a face-to-face hearing on the company to grasp the outline and problems of the company's business process, and who uses this software to give diagnosis about the direction (category) of computerization, the business process efficiency, the current computerization condition, readiness to advance computerization, and business performance management fields as well as presenting solutions to the problems. This method provides a guideline on whether or not to invest in computerization, or what computerization investment is to be made, based on the present business process condition.

### SUMMARY

Those conventional methods have problems given below.

The equipment investment management method of JP 2001-188827 A uses only the amount of money invested in comparison between equipment investment and business cash flow. The method therefore does not clarify how the equipment in which investment is made has been utilized and how much the equipment investment has contributed to business cash flow. In the first place, a simple comparison between the equipment investment amount and business cash flow does not yield a correct causal relation between the two since business cash flow does not depend solely on equipment investment but is influenced by other factors.

Furthermore, the method merely displays the equipment investment amount and business cash flow on the same graph in an overlapping manner, a qualitative presentation of a causal relation between the two. In order to obtain a quantitative understanding of an association between the two, an analyst has to take another measure for a separate analysis.

The simple diagnosis method about computerization which employs the simple computerization diagnosis software according to JP 2002-352060 A uses results of a face-to-face hearing conducted on proprietors and employees of a company to be diagnosed. The hearing results contain subjective views by the proprietors and employees interviewed, and therefore do not make an objective analysis.

In addition, the diagnostician chooses an answer to such a question item as “does the proprietor have a great interest in IT?” based on his/her evaluation of the hearing results which are constituted of top executives'/department heads' views on the corporate strategy, important business developments, and needs for computerization, current problems viewed by person in charge of the existing information system, and the like. Since a subjective evaluation of the hearing results by the diagnostician makes the basic data of analysis in this method, the diagnosis is subject to diagnostic skills and experience of the diagnostician.

It is therefore an object of this invention to provide system quantitatively estimating the effect of investment in an IT system on the basis of objective information on the IT system while screening out information that is based on subjective views by proprietors and employees of a company to be evaluated and eliminating information evaluation dependent on diagnostic skills and experience of diagnosticians.

In order to solve those problems and attain the above object, this invention uses data about profit obtained from a business system (revenue indicator), data indicative of the progress status of a business process (business process progress status indicator), and data indicative of the operation status of an IT system (system operation status indicator), and analyzes the correlation between the data. Thus system quantitatively evaluating influence of the operation status of the IT system over profit is provided.

This invention is comprised of, for the purpose of evaluating influence of the operation status of an IT system over profit, first unit analyzing the correlation between data classified as a system operation status indicator and data classified as a business process progress status indicator, second unit analyzing the correlation between data classified as a business process progress status indicator and data classified as a revenue indicator, and third unit analyzing the correlation between data classified as a system operation status indicator and data classified as a revenue indicator by integrating the first two correlations.

This invention is further comprised of fourth unit calculating, from the above-described correlation between data classified as a business process progress status indicator and data classified as a revenue indicator, the impact (contribution ratio) of data classified as a system operation status indicator on data classified as a revenue indicator and then calculating, from the contribution ratio as well as the revenue indicator data, a profit derived from the IT system, and fifth unit calculating the effect of investment in the IT system taking into account the calculated profit and the cost necessary to build and run the IT system.

This invention makes it possible to evaluate the correlation between company profit and an IT system quantitatively, so that the effect of investment can be measured with precision. This invention is also capable of providing a guideline on improvement of the IT system configuration to increase profit based on the correlation between an IT system operation status indicator, a business process progress status indicator, and a revenue indicator. In addition, the invention enables a user to detect a bottleneck in an IT system that adversely affects profit and to readjust the system configuration accordingly.

### BRIEF DESCRIPTION OF THE DRAWINGS

FIG. 1 is a system configuration diagram showing an embodiment of this invention.

FIG. 2 is a function block diagram showing the configuration of an IT investment effect measuring system according to this invention.

FIG. 3 is a function block diagram of a data input unit according to this invention.

FIG. 4 is a function block diagram of a system-business correlation structure estimating unit according to this invention.

FIG. 5 is a function block diagram of a system-profit correlation structure estimating unit.

FIG. 6 is a function block diagram of an investment effect calculating unit.

FIG. 7 is an explanatory diagram showing an example of data outputted from a log output mechanism.

FIG. 8 is an explanatory diagram showing an example of items and values set to data attributes.

FIG. 9 is an explanatory diagram showing an example of system-profit correlation structure parameters displayed.

FIG. 10 is a system configuration diagram of a call center.

FIG. 11 is a business flow chart for the call center.

FIG. 12 is an explanatory diagram showing log data items collected at the call center.

FIG. 13 is an operation flow chart for an impact-on-profit evaluating unit.

FIG. 14 is an explanatory diagram showing an example of an impact-on-profit evaluation result displayed.

FIG. 15 is an operation flow chart for an improvement method analyzing unit.

FIG. 16 is an explanatory diagram showing an example of system configuration parameters.

FIG. 17 is an explanatory diagram showing an example of hardware component information.

### DETAILED DESCRIPTION OF THE PREFERRED EMBODIMENTS

An embodiment of this invention will be described below with reference to the accompanying drawings.

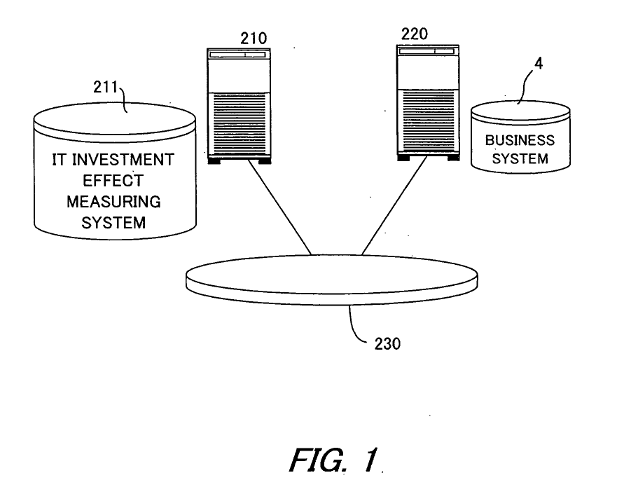

FIG. 1 is a system configuration diagram showing an embodiment of this invention.

In FIG. 1, a business system 4 (IT system) is in operation in a computer 220, which is connected via a network 230 to a computer 210 where an IT investment effect measuring system 211 of this invention is run. Here, an example is shown in which the business system 4 is an IT system that is the subject of measurement by the IT investment measuring system 211.

The term “IT system” refers to information communication system, for example, a system composed of hardware and software with which a business is carried out.

The business system 4 has a mechanism to send to the computer 210 log data which indicates the operation status of the system. The IT investment effect measuring system 211 run on the computer 210 receives the log data and analyzes the log data as will be described later to measure the effect of investment in the IT system.

Not-shown input devices such as a keyboard and a mouse are connected to the computer 210, enabling an analyst to control processing. Also connected to the computer 210 are not-shown output devices such as a display and a printer, which are for displaying measurement results and analysis results. A storage system such as a hard disk connected to the computer 210 makes it possible to record data sent from the business system 4, interim analysis data, and the like at any time.

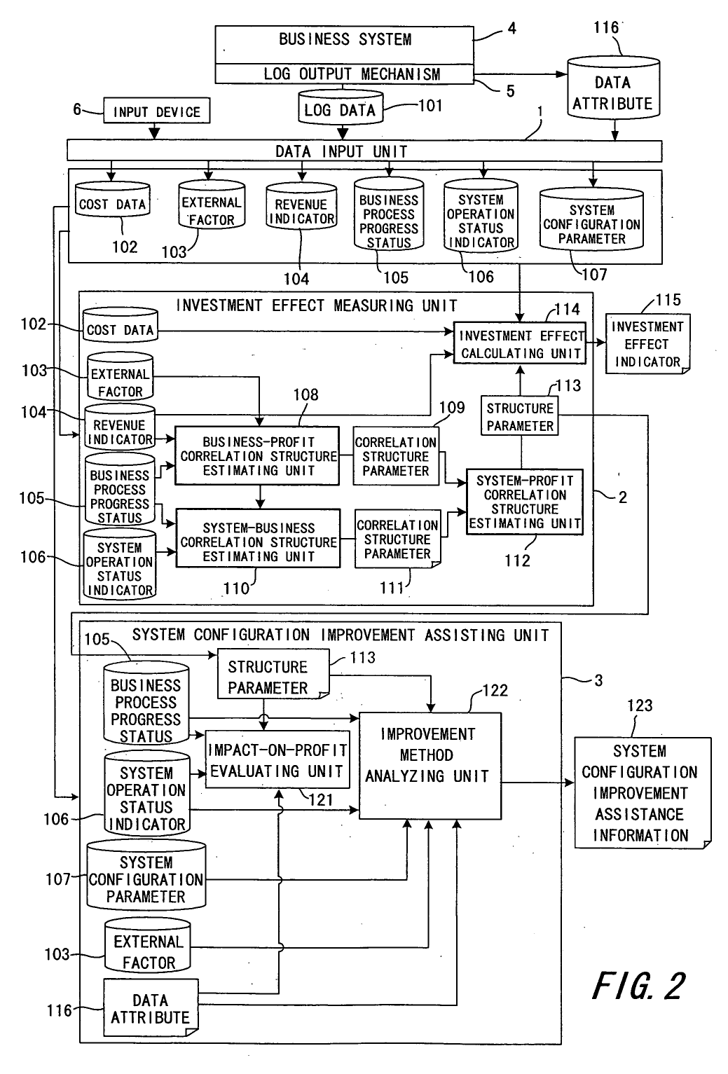

FIG. 2 is a function block showing the configuration of the IT investment effect measuring system 211 according to this invention.

The IT investment effect measuring system 211 according to this invention is composed of a log output mechanism incorporated in the business system 4; a data input unit 1 which reads and sorts log data (time-series data) outputted; an investment effect measuring unit 2 which uses data sorted by the data input unit 1 to measure the effect of IT investment; and a system configuration improvement assisting unit 3 which monitors the operation status of the business system 4 through log data, detects a bottleneck that adversely affects profit, and optimizes the system configuration in a manner that maximizes the effect of investment.

The operation of the respective units will be described in detail below. In this embodiment, a call center is taken as an example of the business system 4, which is the subject of investment effect measurement.

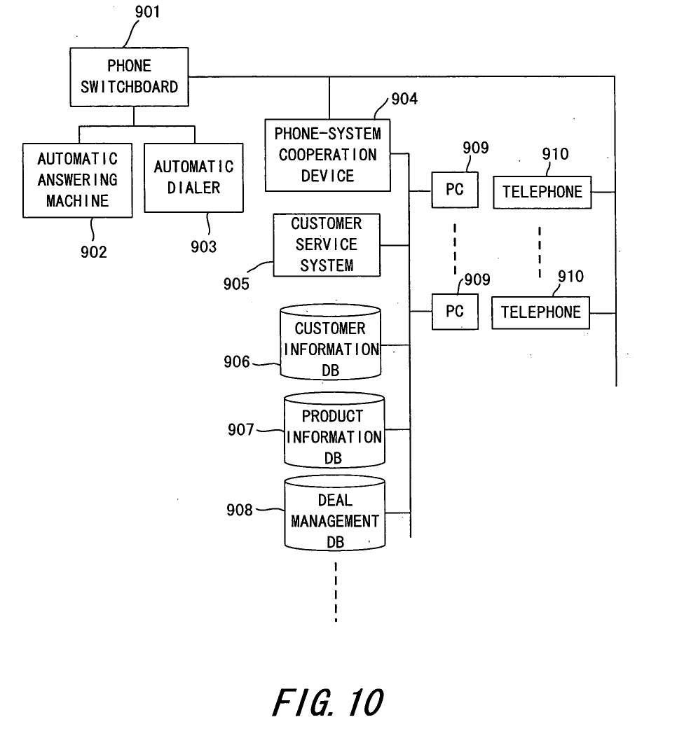

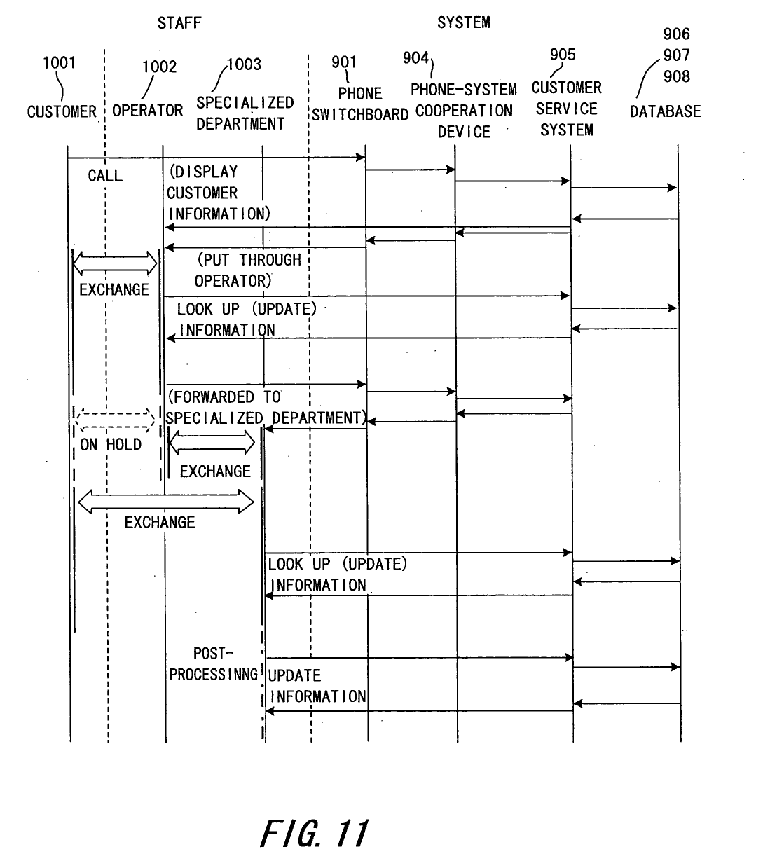

A system of a call center is shown in FIG. 10. At the call center, dedicated operators take calls from customers to answer customers' questions about products and services, promote new products, and take orders. In some cases, the operators make calls to customers for sales and aftercare services. For quick and correct handling of such calls, the operators need to obtain, on site, customers' history of purchases, past inquiries made to the call center, information on new products, and the like while talking with customers.

The call center system shown in FIG. 10 attains these objects by integrating telephones and an information system in a manner that enables the operators to promptly obtain information necessary to deal with customers.

The information system is composed of a switchboard 901 which puts a call from a customer through an operator; a phone-system cooperation device 904 which controls cooperation between telephones and systems; a customer service system 905 which assists in retrieval and update of information necessary to deal with customers; a customer information database 906 which stores customers' basic attributes such as age and sex and history of purchases; a product information database 907 which stores information on products in product lineup; a deal management database 908 for management of past deals; client PCs 909 through which operators in their cubicles manipulate the customer service system; and telephones 910 on which operators talk with customers. In this example, the switchboard 901, the phone-system cooperation device 904, the customer service system 905, the databases 906, 907 and 908, and a server where the above components operate correspond to the business system 4 shown in FIGS. 1 and 2.

The information system may further has an automatic answering machine 902 and an automatic dialer 903 for quicker answering to or contact to customers and resultant improvement in business efficiency.

How the call center business is carried out with the use of this system will be described referring to a business flow diagram of FIG. 11.

In FIG. 11, first, a call from a customer 1001 to the call center is received by the switchboard 901. As the switchboard 901 receives the call, the phone-system cooperation device 904 connected to the switchboard notifies the customer service system 905 of reception of the call, along with an operator 1002 who is to take this call and the phone number of the caller which is notified by a caller identification service. The customer service system 905 accesses the customer information database 906 to retrieve customer information of the caller using the phone number of the caller, and displays the obtained information on one of the client PCs 909 that is used by the corresponding operator 1002. Meanwhile, the switchboard 901 puts the call through the operator 1002, who starts talking with the customer 1002 referring to the information displayed on his/her client PC.

During the discourse with the customer 1001, the operator 1002 retrieves or updates information as the need arises on a screen of the customer service system 905 displayed on his/her client PC 909. At the command from the operator, the customer service system 905 accesses the databases 906, 907 and 908 to retrieve or update information.

In the case where the customer 1001 asks technical questions that are beyond the knowledge of the operator 1002, the operator 1002 forwards the call to a specialized department 1003 that can answer such questions. Notified by the switchboard 901 of the forward call, the phone-system cooperation device 904 instructs the customer service system 905 to provide necessary information to the specialized department to which the call is forwarded. The customer service system 905 follows the instruction and provides one of the client PCs 909 that is used by the specialized department 1003 with the information that is currently provided to the operator 1002.

Receiving the forwarded call, the specialized department 1003 takes over dealing with the customer 1001 while retrieving or updating necessary information through the customer service system 905 as the operator 1002 did. When the customer 1001 is satisfied and ends the call, the contents of the call are recorded and arrangements necessitated by the call, whether it may be an order for a product or a request for repair, are made as post-processing.

In the call center business, the progress of the business is in this close conjunction with the call center system; the system operation status greatly influences the progress of the business and, resultantly, profit.

In practice, however, profit is not dependent solely on the system operation status and generally influence of the system over profit is merely one of factors that cause changes in profit. It is therefore necessary in evaluation of the effect of investment in the system to know to what extent the system operation status contributes to profit and to assess a profit that is derived from the system by checking the actual operation status.

This call center business is taken as an example to give a description on how a method and device of measuring the effect of investment in an IT system according to this invention evaluate profit brought by the system and measure the investment effect.

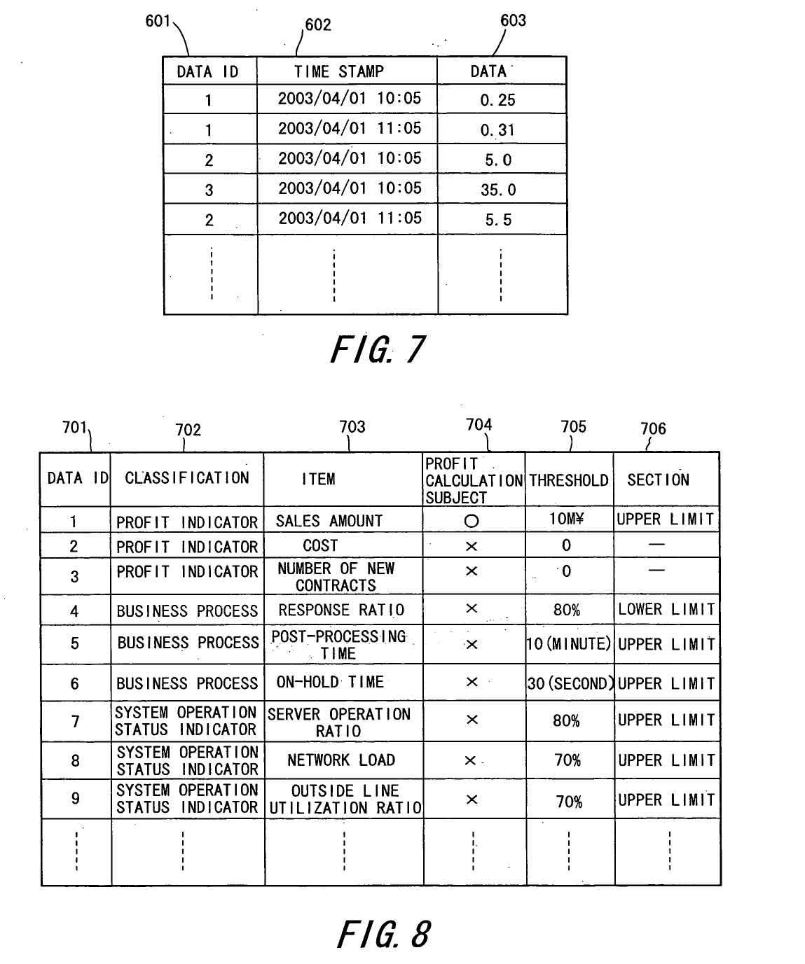

A log output mechanism 5 is incorporated in the business system 4 shown in FIG. 2 to output necessary data at regular time intervals. Data items outputted by the log output mechanism 5 are as shown in FIG. 7, and include, at least, a data ID 601 indicating the type of data, a time stamp 602 indicating the time the data is obtained, and a data value 603. The log output mechanism 5 therefore consults a data attribute 116 in order to sort output data by type and set data ID as shown in FIG. 2.

The data attribute 116 is, as shown in FIG. 8, a set of data constituted of a data ID 701, a classification 702, a data item name 703, a profit calculation subject flag 704 indicating whether data is a subject of profit calculation or not, a monitor threshold 705 used in the system configuration improvement assisting unit 3, which will be described later, and a section flag 706 indicating whether the threshold 705 is an upper limit value or a lower limit value. The attribute is set in advance for every type of data stored in the log data. The data ID 701 is consistent with the data ID 601 shown in FIG. 7, so data attributes (the classification 702, the item 703, the profit calculation subject flag 704, and other attributes) are identified by referring to the data attribute 116 with the data ID 601 as a key. The data attribute 116 is also consulted by the data input unit 1 of FIG. 2 and other components as will be described later. It is therefore necessary to make the data attribute 116 available for reference to the IT investment effect measuring system 211 in the case where the business system 4 holds the data attribute 116. Alternatively, the data attribute 116 may be placed in another computer to be shared between the business system 4 and the IT investment effect measuring system 211.

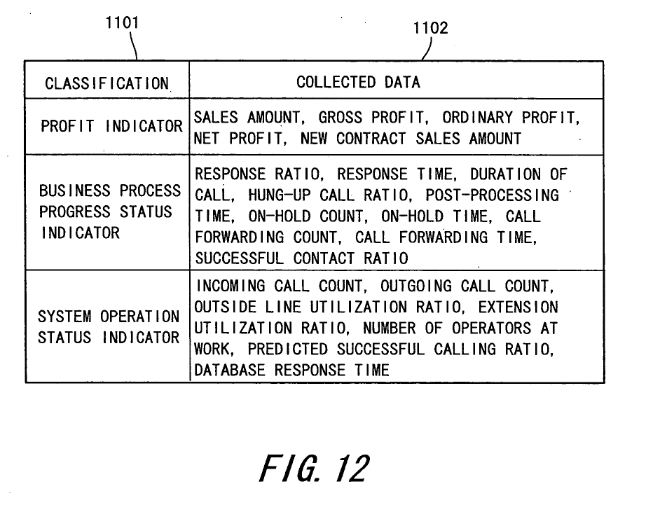

FIG. 12 shows an example of data items collected by the call center system shown in FIG. 10. The data is collected from the switchboard 901, the phone-system cooperation device 904, the customer service system 905, the databases 906, 907 and 908, the server on which these components operate, and others.

The data input unit 1 of FIG. 2 sorts log data 101, which is outputted from the log output mechanism 5, to create data for analysis.

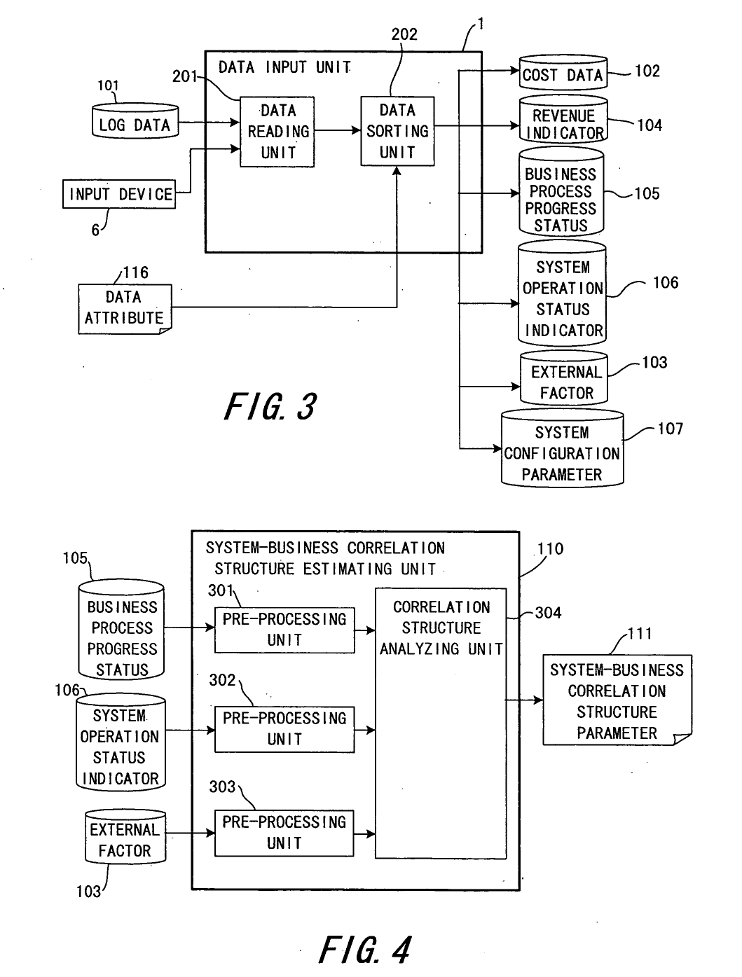

A function block diagram of the data input unit 1 is shown in FIG. 3. The data input unit 1 is composed of a data reading unit 201 and a data sorting unit 202 which are function components. As has been mentioned, the data input unit has an input device 6 (a display, a keyboard, a mouse, a network device, etc. which are not shown in the drawing) to allow separate input of data that is not contained in the log data 101. The input device 6 also includes module collecting information from a network such as the Internet.

The data reading unit 201 reads data from the log data 101. The read data is sent as it is to the data sorting unit 202, where the data ID 601 in the read data is checked against the data ID 701 in the data attribute 116 and the data is sorted according to the classification 702 of the item that matches.

Every read data is classified as one of cost data 102 related to the cost to build and run the IT system, a revenue indicator 104 indicating profit of the company, a business process progress status indicator 105 indicating the progress status of the business process, a system operation status indicator 106 indicating the operation status of the IT system, an external factor 103 representing an external factor that could have influence over profit (weather conditions, economic trend, and the like), and a system configuration parameter 107 representing the current system configuration. Here, the cost data 102 and the revenue indicator 104 are outputted from the business system 4. The term “business process” refers to the unit of activity or work in a company, for example, units constituting such elements as purchase, manufacture, sales, distribution, and customer support.

FIG. 12 shows an example of data classified as the revenue indicator 104, the business process progress status indicator 105, and the system operation status indicator 106 in the case of the call center system described above. It should be noted that the data shown in FIG. 12 is merely an example and that other data may be used or some of the data in FIG. 12 may not be used.

Data classified as the cost data 102, data classified as the external factor 103, and the system configuration parameter 107 are inputted separately from the log data through the input device 6.

Data sorted in this manner is handed over to the investment effect measuring unit 2 and the system configuration improvement assisting unit 3 to be used for analysis.

The investment effect measuring unit 2 uses, of the data sorted by the data input unit 1, the cost data 102, the external factor 103, the revenue indicator 104, the business process progress status indicator 105, and the system operation status indicator 106 to analyze.

The investment effect measuring unit 2 in FIG. 2 is composed of function components including a system-business correlation structure estimating unit 110 which analyzes the correlation structure between data classified as the system operation status indicator 106 and data classified as the business process progress status indicator 105; a business-profit correlation structure estimating unit 108 which analyzes the correlation structure between data classified as the business process progress status indicator 105 and data classified as the revenue indicator 104; a system-profit correlation structure indicating unit 112 which analyzes the correlation structure between data classified as the system operation status indicator 106 and data classified as the revenue indicator 104; and an investment effect calculating unit 114 which calculates the final effect of investment in the system.

The operation of these function components will be described below.

FIG. 4 is a function block diagram of the system-business correlation structure estimating unit 110. Data classified as the business process progress status indicator 105, data classified as the system operation status indicator 106, and data classified as the external factor 103 are chronologically arranged by pre-processing units 301, 302 and 303, respectively, to supplement missing data and to perform pre-processing such as standardization that makes the average 0 and distribution 1.

Then a correlation analysis processing unit 304 analyzes the correlation for each data that is classified as the business process progress status indicator 105 using, for explanatory variables, data that is classified as the system operation status indicator 106 and data that is classified as the external factor 103.

The description here on the correlation analysis takes as an example a method that uses multiple linear regression analysis. When multiple linear regression analysis is employed, it is assumed that a data item of the business process progress status indicator 105, that of the system operation status indicator 106, and that of the external factor 103 have the following relation:
x_{t,i}=α_{i,1}f_{t,2}α_{i,2}f_{t,2}+ . . . +α_{i,n}f_{t,n}+β_{i,1}g_{t,1}, + . . . +β_{i,m}g_{t,m}+ε
x_{t,i}: an i-th data item classified as a business process progress status indicator
f_{t,i} an i-th data item classified as a system operation status indicator
g_{t,i}: an i-th data item classified as an external factor
α_{i,n}, β_{i,m}: regression coefficient
ε_{t,i}: residual term

Actually obtained data is used to calculate a regression coefficient by the following formula:

$${A}_{i} = {( {H}^{t} H )}^{- 1} {H}^{t} {X}_{i}$$

$${A}_{i} = {( \begin{matrix}{α}_{i , 1} & {α}_{i , 2} & ⋯ & {α}_{i , n} & {β}_{i , 1} & {β}_{i , 2} & ⋯ & {β}_{i , m}\end{matrix} )}^{t}$$

$$H = ( \begin{matrix}{f}_{1 , 1} & {f}_{1 , 2} & ⋯ & {f}_{1 , n} & {g}_{1 , 1} & {g}_{1 , 2} & ⋯ & {g}_{1 , m} \\ {f}_{2 , 1} & & & & & & & \\ ⋮ & & & ⋰ & & & & ⋮ \\ {f}_{t , 1} & & & ⋯ & & & & {g}_{t , m}\end{matrix} )$$

$${X}_{i} = {( \begin{matrix}{x}_{1 , i} & {x}_{2 , i} & ⋯ & {x}_{t , i}\end{matrix} )}^{t}$$

The calculated regression coefficient serves as a parameter that represents the correlation between an item included in the business process progress status indicator 105 and an item included in the system operation status indicator 106.

This processing is performed on every data item that is included in the business process progress status indicator 105, and the resultant group of regression coefficients is outputted as a system-business correlation structure parameter 111.

The business-profit correlation structure estimating unit 108 performs the same processing as the system-business correlation structure estimating unit 110 shown in FIG. 4, except that the business process progress status indicator 105 which is input data in FIG. 4 is replaced by the revenue indicator 104, the system operation status indicator 106 which is input data in FIG. 4 is replaced by the business process progress status indicator 105, and the system-business correlation structure parameter 111 which is the output result in FIG. 4 is replaced by a business-profit correlation structure parameter 109.

As shown in FIG. 5, the system-profit correlation structure estimating unit 112 reads the system-business correlation structure parameter 111 outputted from the system-business correlation structure estimating unit 110 and the business-profit correlation structure parameter 109 outputted from the business-profit correlation structure estimating unit 108. The parameters read are used by a structure parameter integrating unit 401 to calculate a coefficient of the correlation structure between a data item of the revenue indicator 104 and a data item of the system operation status indicator 106 through the following formula:

$${η}_{k , i} = {\sum }_{j = 1}^{n} {α}_{ji} \times {γ}_{k , j}$$

α_{j,i}: the regression coefficient of a j-th data item of the system operation status indicator to the i-th data item of the business process progress status indicator
γk,j: the regression coefficient of a j-th data item of the business process progress status indicator to a k-th data item of the revenue indicator ‘ηk,j: the regression coefficient of the i-th data item of the system operation status indicator to the k-th data item of the revenue indicator

The calculation result is used by a contribution ratio calculating unit 402 to calculate the contribution ratio of a data item of the system operation status indicator 106 to a data item of the revenue indicator 104 through the following formula:
r_{k,i}=η_{k,i}²

The contribution ratio is outputted, along with the previously obtained system-business correlation structure parameter 111 and business-profit correlation structure parameter 109, as a system-profit correlation structure parameter 113.

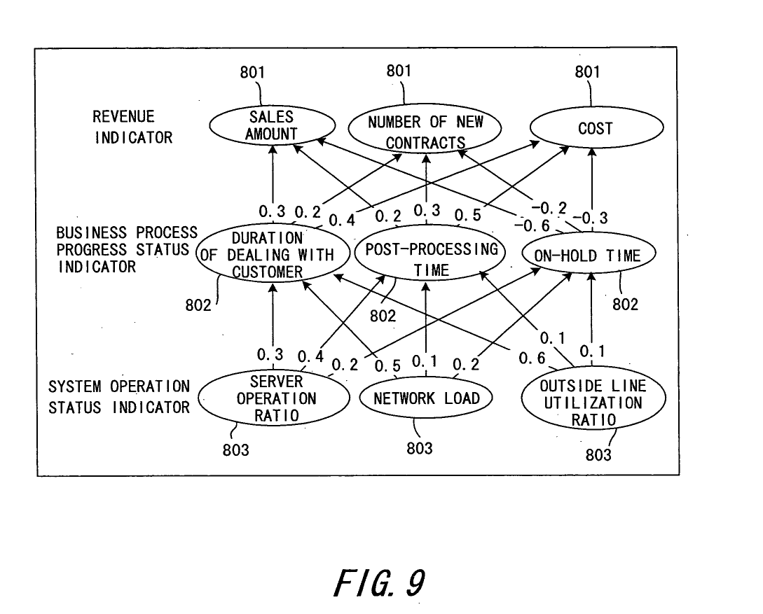

The system-profit correlation structure parameter 113 is outputted to a display device or the like in a manner as the one shown in FIG. 9. This enables the analyst to visually grasp the correlation structure between data collected from the business system 4, and helps the analyst to understand how the IT system contribute to profit.

FIG. 9 shows an example of displaying the sales amount, the number of new contracts, and the cost (cost data) in the upper area as elements of a revenue indicator 801, the duration of dealing with customers, post-processing time, and on-hold time in the middle area as elements of a business process progress status indicator 802, and the server operation ratio, the network load, and the outside line utilization ratio in the lower area as elements of a system operation status indicator 803. The contribution ratio obtained by the above calculation is displayed between each two elements. For instance, according to FIG. 9, 0.3 of the server operation ratio contributes to the duration of dealing with customers and 0.3 of the duration of dealing with customers contributes to the sales amount. 0.5 of the network load contributes to the duration of dealing with customers, and 0.6 of the outside line utilization ratio contributes to the duration of dealing with customers. Thus the relation of the IT system operation status and business process progress status to the revenue indicator is made clear.

Although a method employing multiple linear regression analysis is shown here as the method of analyzing the correlation, similar correlation structure parameters can be calculated by other methods including one that uses factor analysis in combination with multiple linear regression analysis and one that uses covariance structure analysis.

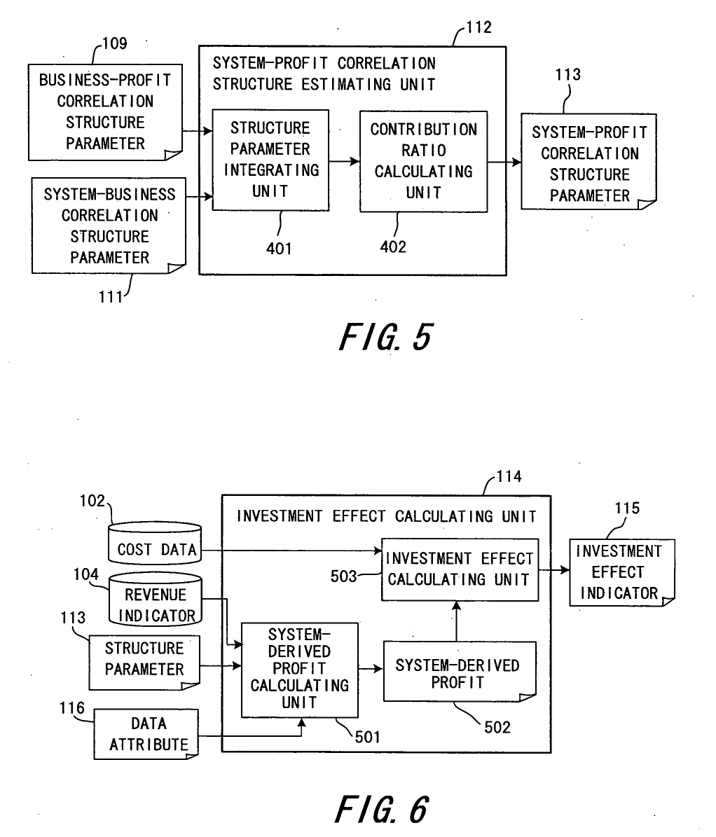

The thus calculated system-profit correlation structure parameter 113 is sent to a system-derived profit calculating unit 501 of the investment effect calculating unit 114 shown in FIG. 6. The system-derived profit calculating unit 501 first reads the data attribute 116 and refers to the profit calculation subject flag 704 shown in FIG. 8 to specify data items for use in calculation of profit. The system-derived profit calculating unit 501 then reads the revenue indicator data 104 and extracts, from the read data, data items that are subjects of profit calculation.

Thereafter, the system-derived profit calculating unit 501 reads the contribution ratio between the data items used for profit calculation and the data items of the system operation status indicator 106 from the system-profit correlation structure parameter 113. The contribution ratio read is used together with data of profit calculation data items to calculate a system-derived profit 502 through the following formula:

$$Z = {Y}_{k} \times {\sum }_{i = 1}^{n} {r}_{k , i}$$

Z: system-derived profit
Y: profit calculation subject data

The thus obtained system-derived profit 502 is sent to an investment effect calculating unit 503. The investment effect calculating unit 503 reads the cost data 102, which is used along with the previously sent system-derived profit 502 to calculate an investment effect indicator 115, the final output result of the investment effect measuring unit 2, through the following formula:

$$ROI = \frac{Z}{C}$$

ROI: Return On Investment (investment effect indicator)
C: cost

The system configuration improvement assisting unit 3 is described next. After the investment effect measuring unit 2 estimates the system operation status indicator 106, the business process progress status indicator 105, and the revenue indicator 104, the system configuration improvement assisting unit 3 monitors the system operation status and the business progress status by collecting real time the log data 101 of the business system 4, in order to detect a bottleneck that adversely affects profit and analyzes an improvement guideline on a remedy for the bottleneck.

In FIG. 2, data inputted to the system configuration improvement assisting unit 3 includes the business process progress status indicator 105, the system operation status indicator 106, and the external factor 103 which are outputted from the business system 4; the system configuration parameter 107 which is configuration information of the business system 4; the data attribute 116 which shows attributes of the above data; and the correlation structure parameter 113 which is estimated by the investment effect measuring unit 2. The system configuration improvement assisting unit 3 has an impact-on-profit evaluating unit 121 which monitors the system and the business progress state for evaluation of influence on profit and an improvement method analyzing unit 122 which, based on the evaluated impact, searches for a system configuration improvement idea that can increase profit. The units 121 and 122 provide information necessary to study system improvement measures (system configuration improvement assistance information 123). Given below are details of the operation of the system configuration improvement assisting unit 3.

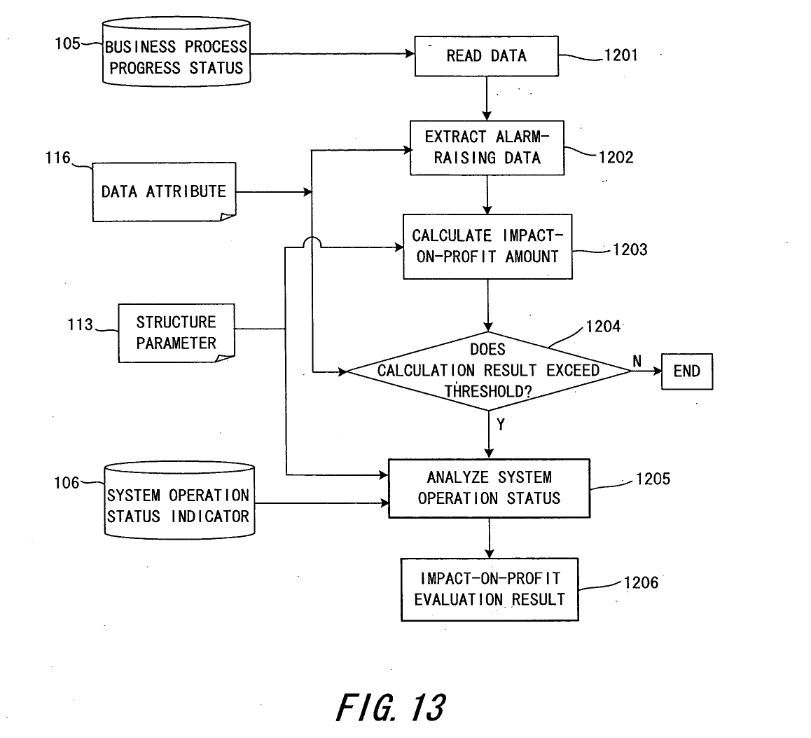

The operation flow of the impact-on-profit evaluating unit 121 is shown in FIG. 13. The impact-on-profit evaluating unit 121 first reads the business process progress status indicator 105 (1201) and refers to the threshold 705 and the section 706 which are recorded for each data item in the data attribute 116 shown in FIG. 8 to judge whether a data item classified as the business process progress status indicator 105 meets an alarm-raising condition or not. This processing is performed on every data item classified as the business process progress status indicator 105 to extract alarm-raising data items which meet the alarm-raising condition (1202). Data is extracted as alarm-raising data when the business process progress status indicator 105 read is over, or under, the threshold 705 depending on the section 706.

When extraction of alarm-raising data is finished, a coefficient of the correlation structure between data items of the business process progress status indicator that are extracted as alarm-raising data and profit calculation subject data is retrieved from the system-profit correlation structure parameter 113. The product of the obtained correlation structure coefficient and the difference of an alarm-raising data value from the threshold is calculated. This processing is performed on every alarm-raising data, and the impact-on-profit amount is calculated as the sum of the obtained products (1203).

The thus obtained impact-on-profit amount is compared against the threshold 705 of the profit calculation subject data to judge whether there is more adverse affect on profit than acceptable or not (1204). When it is judged as a result that there is no adverse affect on profit that exceeds the acceptable level, the processing is ended at this point.

When it is judged as a result that there is more adverse affect on profit than acceptable, system operation status analysis processing 1205 is executed. In the system operation status analysis processing 1205, the system-profit correlation structure parameter 113 is looked up for a coefficient of the correlation structure between the system operation status indicator 106 and the business process progress status indicator 105 to extract data items of the system operation status indicator 106 that are greatly correlated with alarm-raising data. Data values of the extracted data items are read out of the system operation status indicator data 106, and the threshold 705 is read from the data attribute 116.

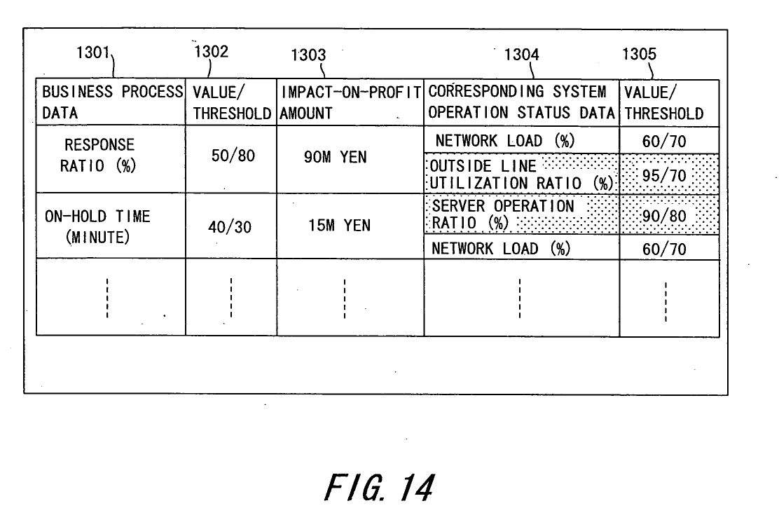

The thus collected data is displayed as an impact-on-profit evaluation result 1206 on the display device. A display example of the evaluation result is shown in FIG. 14. In FIG. 14, items of the business process progress status indicator 105 that are extracted as alarm-raising data are listed under business process data 1301. Also displayed are data values and thresholds 1302 of the items, and an impact-on-profit amount 1303 of the items. Data items 1304 of the system operation status indicator that are greatly correlated with the items, and data values and thresholds 1305 of the data items 1304 are also listed in the display. A data item of the system operation status indicator that exceeds the threshold is displayed in a manner that makes it easy to discriminate, for example, by coloring its display field. The thresholds 1302, which are thresholds for the items of the business process data 1301, and the thresholds 1305, which are thresholds for the items of the corresponding system operation status data 1304, are read from the data attribute 116.

In this example, the response ratio of the business process data 1301 is lower than the section 706 (lower limit) of the threshold 705 set in the data attribute 116 of FIG. 8. The corresponding system operation status data 1304 that corresponds to the response ratio is the outside line utilization ratio, which exceeds (at 95%) the section 706 (upper limit) of the threshold 705 (70%) set in the data attribute 116. The utilization ratio is therefore extracted as alarm-raising data, and the amount of resultant impact-on-profit is displayed (90 million yen). Similarly, the on-hold time of the business process data 1301 exceeds the section 706 (upper limit) of the threshold 705 set in the data attribute 116, and the server operation ratio as the corresponding system operation status data 1304 that corresponds to the on-hold time exceeds (at 90%) the upper limit threshold 80% set in the data attribute 116. The server utilization ratio is therefore extracted as alarm-raising data, and the amount of resultant impact-on-profit is displayed (15 million yen).

This enables the analyst to promptly detect which operation status (business process) of the information system is causing a problem.

When the impact-on-profit evaluating unit 121 in FIG. 2 detects a bottleneck in operation process that adversely affects profit, the improvement method analyzing unit 122 assists the analyst in analyzing a method of improving the system configuration that eliminates the bottleneck.

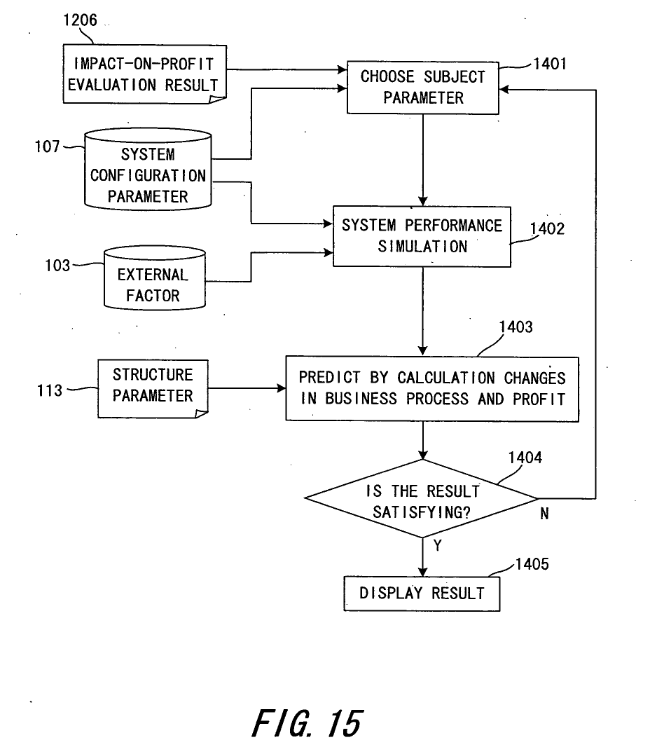

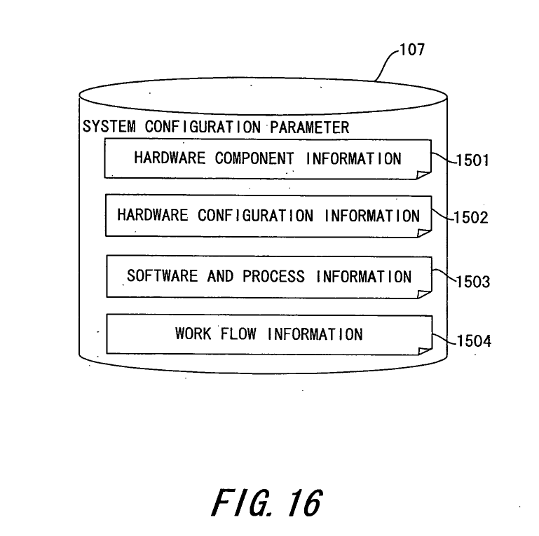

FIG. 15 shows the operation flow of the improvement method analyzing unit 122. Upon receiving the impact-on-profit evaluation result 1206 from the impact-on-profit evaluating unit 121, the improvement method analyzing unit 122 reads the system configuration parameter 107 created by the data input unit 1. The system configuration parameter 107 is outlined in FIG. 16. The system configuration parameter 107 contains: information 1501 on a server, a network device, and other components that constitute the system; information 1502 on the hardware configuration of the system such as the form of connection between components; information 1503 on software and process operating on a server; information 1504 on the work flow which shows the cooperation relation of the software and the process; and other information.

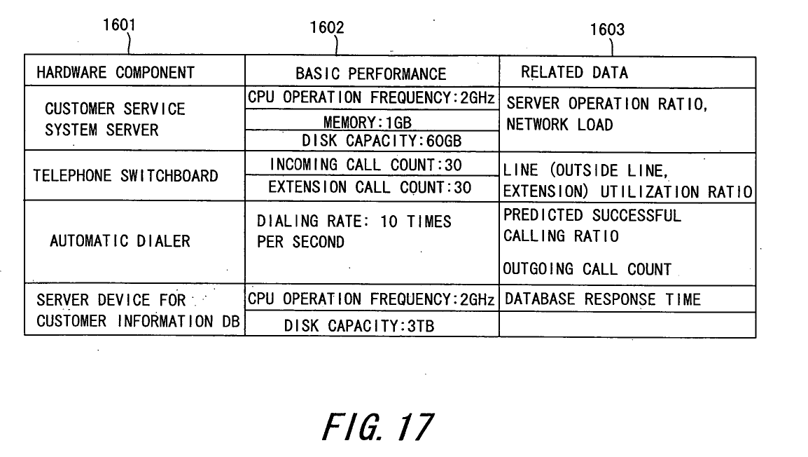

An example of the hardware component information 1501 is shown in FIG. 17 as an example of the system configuration parameter 107. The hardware component information 151 contains a set of a hardware component name 1601, basic performance data 1602, and a related system operation status indicator data item 1603. The analyst can know a system component to be modified for improvement of a specific system operation status by consulting the hardware component information 1501.

Once reading the data, the improvement method analyzing unit 122 moves on to processing of choosing a system configuration parameter that is to be modified in FIG. 15 (1401). In this processing, as shown in FIG. 14, the analyst first looks over the impact-on-profit evaluation result 1206, displayed on the display device and chooses, on the display screen, a data item of the system operation status indicator that the analyst desires to improve. The improvement method analyzing unit 122 consults the system configuration parameter 107 to extract a parameter related to the chosen data item.

The value of the extracted parameter is changed and the external factor data 103 is read before a system performance simulation is executed (1402). The system performance simulation provides a system operation status prediction result after the parameter change. Then data of the system-profit correlation structure parameter 113 is consulted to calculate influence on the business process and profit (1403).

When the calculation result is satisfactory (for instance, when the change of the system component improves the contribution ratio to profit or directly increases profit), the simulation result about the component is displayed and the processing is ended (1405). When the calculation result is not satisfactory, the parameter value is changed once more and simulation is executed with the new value (1404).

Whether the result is satisfactory or not may be judged by the analyst or by the improvement method analyzing unit 122. In the latter case, a threshold is set in advance.

The final result obtained through this processing is a system improvement measure that can contribute to increase in profit as the analyst intends, and the analyst can form a plan of system configuration change based on this result.

The IT investment effect measuring system 211 can measure the effect of investment at any time. For instance, the investment effect measuring unit 2 and the system configuration improvement assisting unit 3 may execute their respective processing each time the revenue indicator 104 is established (e.g., quarterly settlement, monthly sales amount, or monthly profit) from the log data 101 which is outputted from the business system 4 and collected and accumulated by the data input unit 1.

The log output mechanism 5 of the business system 4 may hold the log data 101 until the data input unit 1 requests the log output mechanism 5 to send the accumulated log data 101 at once. The log data 101 may be obtained from the data input unit 1 upon execution of investment effect measurement.

Alternatively, the log data 101 may be obtained on a steady basis, so the above evaluation of influence on profit and analysis for improvement of the IT system configuration are started when data of the business process progress state indicator 105 read and data of the revenue indicator 104 read meet, or do not meet, preset conditions. For instance, the analysis is started when there is a great change in revenue indicator 104 or when the contribution ratio is lower than a given value.

The revenue indicator 104 and the cost data 102, which are obtained from the business system 4 in the above embodiment, may be inputted from the input device 6.

The revenue indicator 104 is not limited to sales amount and other financial data such as profit or profit rate may be employed instead.

The IT investment effect measuring system 211 and the business system 4, which are executed by the different computers 210 and 220 in the above embodiment, may be executed by the same computer.

The subject of measurement of the effect of IT investment is the business system 4 or a call center in the above embodiment. This is for exemplification only and any part or the entirety of hardware and software introduced by a company can be the measurement subject.

As has been described, this invention is applicable to an IT system consulting business which suggests the optimum IT system configuration in building an IT system. This invention is also applicable to an operation and management service business which constantly monitors the operation status of an existing IT system and analyzes the monitor results to improve the system configuration.

While the present invention has been described in detail and pictorially in the accompanying drawings, the present invention is not limited to such detail but covers various obvious modifications and equivalent arrangements, which fall within the purview of the appended claims.

1. An IT system investment effect measuring method, comprising:
collecting, from a measurement subject IT system, revenue indicator data, which indicates profit performance of a company, business process progress status indicator data, which indicates the progress status of a business process, and system operation status indicator data, which indicates the operation status of the IT system;
analyzing a correlation between the business process and profit from the revenue indicator data and from the business process progress status indicator data;
analyzing a correlation between the operation status of the IT system and the business process progress status from the business process progress status indicator data and from the system operation status indicator data;
analyzing a correlation between the operation status of the IT system and profit from the correlation between the business process and profit and from the correlation between the IT system operation status and the business process progress status;
obtaining a contribution ratio, which represents influence of the IT system on profit, from the correlation between the IT system operation status and profit; and
calculating a profit derived from the IT system using the contribution ratio and the revenue indicator data.

2. The IT system investment effect measuring method according to claim 1, further comprising calculating the effect of investment in the IT system from the IT system-derived profit and from a cost of introducing or running the IT system.

3. The IT system investment effect measuring method according to claim 1, further comprising:
comparing the business process progress status indicator data against a preset alarm-raising condition;
extracting, when a value of the business process progress status indicator data is found to meet the alarm-raising condition as a result of the comparison, an item corresponding to business process progress status indicator data that influences profit from preset attribute data;
extracting, from the attribute data, an item of the system operation status indicator data that corresponds to the business process progress status indicator data; and
presenting the extracted item of the business process progress status indicator data and the extracted item of the system operation status indicator data.

4. The IT system investment effect measuring method according to claim 3, further comprising:
selecting, from system operation status indicator data items presented by the item, an item to be improved; and
analyzing an IT system configuration that enables an improvement in the selected item.

5. The IT system investment effect measuring method according to claim 4, further comprising:
extracting system operation status indicator data that influences profit based on the correlation between the IT system operation status and profit;
simulating a system component that improves profit by changing a condition of a system component that affects the system operation status indicator data; and
analyzing a system component that can improve profit based on the simulation result.

6. The IT system investment effect measuring method according to claim 1, wherein the collecting of the revenue indicator data, the business process progress status indicator data, and the system operation status indicator data includes:
reading log data outputted from the IT system; and
sorting the read log data into the revenue indicator data, the business process progress status indicator data, and the system operation status indicator data.

7. The IT system investment effect measuring method according to claim 1, wherein the calculating of the profit derived from the IT system is started when one of the business process progress status indicator data and the revenue indicator data is compared against a preset condition and found to meet the condition.

8. The IT system investment effect measuring method according to claim 5, wherein the analyzing of the IT system component is started when one of the business process progress status indicator data and the revenue indicator data is compared against a preset condition and found to meet the condition.

9. A program for measuring an effect of investment in an IT system, the program causing a computer to function as:
information collecting unit collecting, from a measurement subject IT system, revenue indicator data, which indicates profit performance of a company, business process progress status indicator data, which indicates a progress status of a business process, and system operation status indicator data, which indicates an operation status of the IT system;
business process-profit analyzing unit analyzing a correlation between the business process and profit from the revenue indicator data and from the business process progress status indicator data;
system operation status-business process analyzing unit analyzing a correlation between the operation status of the IT system and the business process progress status from the business process progress status indicator data and from the system operation status indicator data;
system operation status-profit analyzing unit analyzing a correlation between the operation status of the IT system and profit from the correlation between the business process and profit and from the correlation between the IT system operation status and the business process progress status;
contribution ratio calculating unit obtaining a contribution ratio, which represents influence of the IT system on profit, from the correlation between the IT system operation status and profit; and
profit calculating unit calculating a profit derived from the IT system using the contribution ratio and the revenue indicator data.

10. The program according to claim 9, further causing the computer to function as investment effect calculation unit calculating the effect of investment in the IT system from the IT system-derived profit and from a cost of introducing or running the IT system.

11. The program according to claim 9, further causing the computer to function as:
comparison unit comparing the business process progress status indicator data against a preset alarm-raising condition;
business process progress status item extracting unit extracting, when a value of the business process progress status indicator data is found to meet the alarm-raising condition as a result of the comparison, an item corresponding to business process progress status indicator data that influences profit from preset attribute data;
system operation status item extracting unit extracting, from the attribute data, an item of the system operation status indicator data that corresponds to the business process progress status indicator data; and
item presenting unit presenting the extracted item of the business process progress status indicator data and the extracted item of the system operation status indicator data.

12. The program according to claim 11, further causing the computer to function as:
item selecting unit selecting, from system operation status indicator data items presented by the item, an item to be improved; and
system configuration analyzing unit analyzing an IT system configuration that is enables an improvement in the selected item.

13. The program according to claim 12, further causing the computer to function as:
system operation status extracting unit extracting system operation status indicator data that influences profit based on the correlation between the IT system operation status and profit;
simulation unit simulating a system component that improves profit by changing a condition of a system component that affects the system operation status indicator data; and
component analyzing unit analyzing a system component that can improve profit based on the simulation result.

14. The program according to claim 9, wherein the information collecting unit comprises:
reading unit reading log data outputted from the IT system; and
data sorting unit sorting the read log data into the revenue indicator data, the business process progress status indicator data, and the system operation status indicator data.

15. The program according to claim 9, wherein the calculating of the profit derived from the IT system is started when one of the business process progress status indicator data and the revenue indicator data is compared against a preset condition and found to meet the condition.

16. The program according to claim 13, wherein the analyzing of the IT system component is started when one of the business process progress status indicator data and the revenue indicator data is compared against a preset condition and found to meet the condition.

17. An IT system investment effect measuring system comprising:
information collecting unit collecting, from a measurement subject IT system, revenue indicator data, which indicates profit performance of a company, business process progress status indicator data, which indicates the progress status of a business process, and system operation status indicator data, which indicates an operation status of the IT system;
business process-profit analyzing unit analyzing a correlation between the business process and profit from the revenue indicator data and from the business process progress status indicator data;
system operation status-business process analyzing unit analyzing a correlation between the operation status of the IT system and the business process progress status from the business process progress status indicator data and from the system operation status indicator data;
system operation status-profit analyzing unit analyzing a correlation between the operation status of the IT system and profit from the correlation between the business process and profit and from the correlation between the IT system operation status and the business process progress status;
contribution ratio calculating unit obtaining a contribution ratio, which represents influence of the IT system on profit, from the correlation between the IT system operation status and profit; and
profit calculating means for calculating a profit derived from the IT system using the contribution ratio and the revenue indicator data.
